(19) United States
(12) Patent Application Publication
(10) Pub. No.: US 2007/0126297 A1
(43) Pub. Date: Jun. 7, 2007

(54) Shaftless propeller

(76) Inventors: Michael Jacobus Theodorus de Zwart, Emmen (NL); Christiaan Bernhard Maat, Delft (NL); Antoon van Beek, Gouda (NL); Ronald Adrianus Johannes Ostayen, Roosendaal (NL)

Correspondence Address: ABELMAN, FRAYNE & SCHWAB, 666 THIRD AVENUE, 10TH FLOOR, NEW YORK, NY, 10017, US

(21) Appl. No.: 11/479,429

(22) Filed: Jun. 30, 2006

(30) Foreign Application Priority Data
Jun. 30, 2005 (NL) 1029389

(51) Int. Cl. B63H 21/17; H02K 5/12; H02K 5/00; H02K 5/16

(52) U.S. Cl. 310/86; 310/90; 310/87; 440/6; 310/89

(57) ABSTRACT

A shaftless propeller may be made to cooperate with a liquid, with a stator having a circular opening and a rotor mounted in the opening and having an annular rotor body with a multiplicity of inwardly projecting propeller blades, with the bearings between the rotor and stator having a tiltable padded bearing. A propeller of this type is suitable for relatively high capacities and may be used for propelling a vessel, for pumping a liquid or for generating energy from a flow of liquid.

The invention relates to a shaftless propeller comprising a stator having a circular opening and a rotor mounted in said opening and comprising an annular rotor body with a multiplicity of inwardly projecting propeller blades.

A propeller of this type is known from WO-A-03/082669. This known shaftless propeller is used as a propulsion propeller and has specific advantages over conventional propulsion propellers, which are mounted on a shaft, as will be explained hereinafter.

The output of a conventional propulsion propeller, with propeller blades which project radially outward from a hub, may be improved by placing said blades in a nozzle, the tips of the propeller blades moving tightly along the inner wall of the nozzle. A drawback of a configuration of this type is that cavitation may occur at the tips of the propeller blades owing to the difference in pressure over the gap between the tips of the propeller blades and the inner wall of the nozzle. Cavitation both reduces the output of the propeller and causes vibrations and noise. A further drawback when a conventional propeller is used is that the central drive means at the hub impedes the flow through the nozzle. Still a further drawback is that material such as seaweed or the like is liable to become entangled on a propeller configured in this way.

Propulsion propellers which overcome problems of this type are known. In these known propellers, the propeller blades project inwardly from the inner wall of an annular rotor body. The inner wall of the rotor body forms in this case at least a portion of the nozzle, so there is no gap between the propeller blades and the nozzle. At the circumference, the rotor body is mounted in a circular opening in a stator and is driven at the circumference, allowing a hub to be dispensed with. In proximity to the centre line of the propeller, the nozzle is able to continue to pass unimpeded, so that material is also less liable to become entangled on the propeller.

The drive means for a propeller of this type are preferably electrical, permanent magnets being provided at the circumference of the rotor and stator windings being provided around the opening of the stator for driving the rotor in cooperation with the magnets. A drive means of this type has the advantage that few moving parts are required and that said parts may be relatively compact in their configuration.

A shaftless electrically driven propulsion propeller for use in an underwater vessel is, as specified above, known from WO 03/082669. The bearings of the propeller described in this patent comprise a plastics material bearing surface of the rotor and also a plastics material bearing surface, cooperating with said first bearing surface and constructed from segments, of the stator. The bearings are water-lubricated, allowing bearing seals to be dispensed with. The propeller has a capacity of approximately 7.5 kW and a peak propulsion force of approximately 200 kgm.

A drawback of the propeller is that it is merely suitable for relatively low capacities, as a result of the fact that the bearings used are only able to withstand relatively low loads. The aforementioned propeller is therefore also less suitable for use as a bow propeller for a ship.

It is an aim of the invention to provide a shaftess propeller which is suitable for relatively high capacities, for example higher than 20 kW. In particular, it is an object of the invention to provide a shaftless electrically driven propulsion propeller which may be used as a bow propeller for a ship.

This aim is achieved in that the bearings between the rotor and stator comprise a tiltable padded bearing. A bearing of this type is suitble for relatively high loads such as occur at a capacity of greater than 20 kW.

A bearing of this type may be lubricated with surrounding water, allowing bearing seals to be dispensed with. A relatively simple construction is thus obtained. In addition, the surrounding water is able to cool the bearing and the motor.

The tiltable padded bearing preferably comprises a multiplicity of bearing pads which are tiltably connected to the stator and also a bearing surface, cooperating with said bearing pads, of the rotor.

Preferably, the bearing surface of the bearing pads is relatively hard and the bearing surface of the rotor is relatively soft. The bearing pads may, for example, consist of a metal or metal alloy with a hard covering layer for forming the bearing surface. The bearing pad may, for example, consist of hard stainless steel or titanium and the covering layer may, for example, consist of titanium nitride or diamond-like carbon (DLC). The bearing surface of the rotor may, for example, consist of plastics material.

An advantage of this embodiment is that it displays good start-up behaviour. As a result of the fact that the soft surface of the rotor adapts to the hard surface of the bearing pads, a lubrication film is formed even at low speeds. This good start-up behaviour is particularly important in the case of use in a bow propeller, in view of the fact that a propeller of this type often changes its direction of rotation during operation. At higher speeds, the lubrication film is formed as a result of the fact that the tilting of the bearing pads causes a build-up of pressure in the gap between the bearings.

Furthermore, the bearing surface of the rotor preferably consists of a material having a low coefficient of friction with the bearing of the bearing pads such as, for example, high-density polyethylene. An advantage of an embodiment of this type is that the sliding friction between the bearing surfaces is limited at a very low speed prior to the formation of the lubrication film.

A further advantage of the embodiment wherein the bearing surface of the bearing pads is relatively hard and the bearing surface of the rotor is relatively soft is that the bearing is less sensitive to impurities. When the bearing is lubricated with surrounding water, particles such as grains of sand entrained with the water may enter the bearing. However, the soft material permits the embedding of particles, so the functioning of the bearing is not affected or is hardly affected.

The rotor will often remain inoperative for long periods of time, especially when the invention is used as a bow propeller. When the rotor is inoperative, the inherent weight of the rotor rests on the portion of the bearings located on the lower side. Sustained stationary loading of the plastics material bearing surface may lead to creepage, and this has detrimental effects for the formation of a lubrication film. The plastics material bearing surface is therefore preferably attached to the rotor so that when the rotor is inoperative, it is not always the same portion of the plastics material bearing surface that is loaded, since the rotor will not always stop in the same position. The effect of creepage is thus distributed over the region of the bearing surface, thus delaying the onset of any problems.

The bearing pads are preferably carried by a carrier element consisting of a resilient material such as rubber. An embodiment of this type provides a simple method for the tiltable connection of the bearing pads to the stator.

The bearings according to the invention are preferably used for both the axial and the radial bearings of the rotor.

The invention has been described above with reference to a propeller forming part of the propulsion installation of a vessel. The invention therefore also relates to a propeller/motor unit comprising a propeller of this type, at the circumference provided with permanent magnets, and also stator windings, provided around the opening of the stator, for driving the rotor in cooperation with the magnets.

The invention further encompasses a propeller/generator unit comprising a propeller as described above, wherein the rotor may be driven by a flow of liquid through the rotor, stator windings provided around the opening of the stator and also permanent magnets, provided at the circumference of the rotor, for generating an electric current in the stator windings when the rotor is driven.

Finally, the invention also relates to a pump comprising a pump housing with a pump chamber and also a supply means and a discharge means which are connected to the pump chamber, a propeller/motor unit as described above being located in the pump chamber, and also a generator provided with a generator housing and also a supply means and a discharge means which are connected to the generator housing, a propeller/generator unit as described above being located in the generator housing.

The invention will be described hereinafter with reference to an embodiment illustrated in the following drawings, in which:

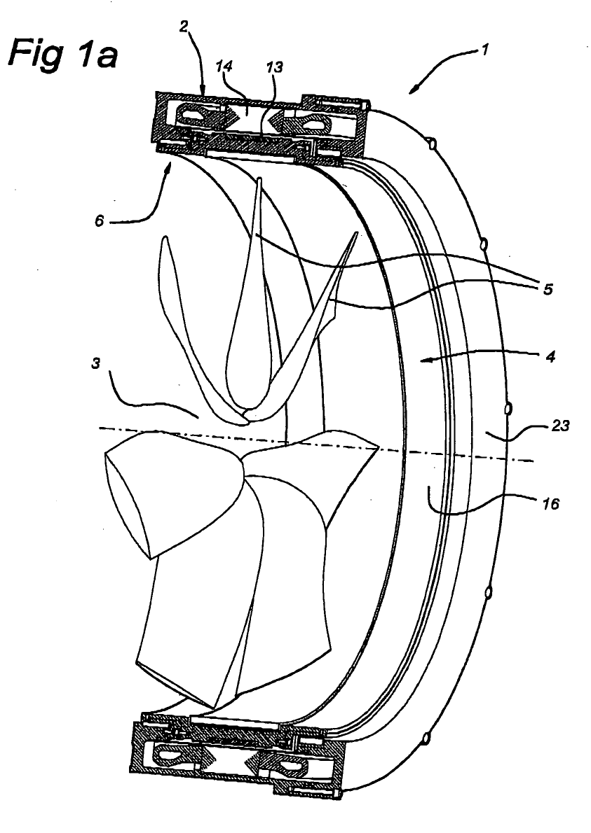

FIG. 1 is a partially exploded view of a propulsion propeller according to the invention;

FIG. 1b is a view in the axial direction of the propulsion propeller;

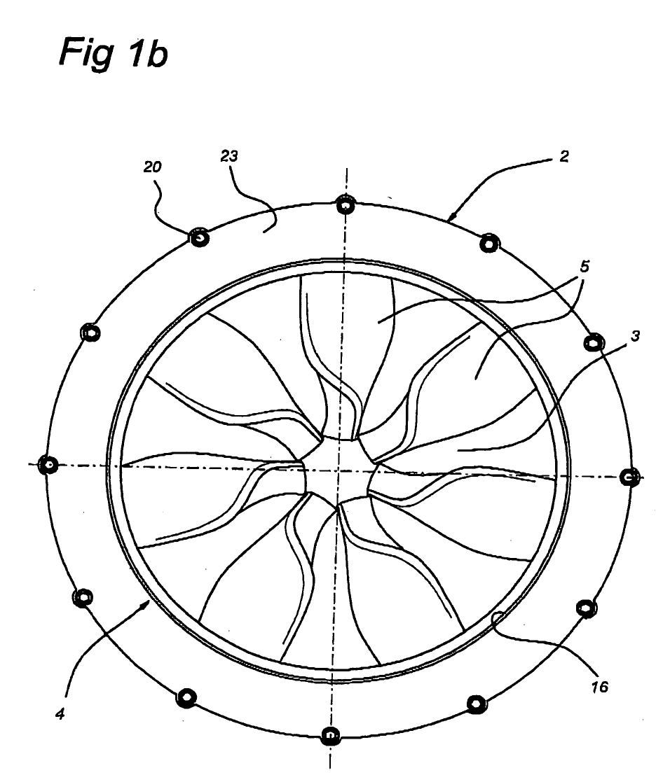

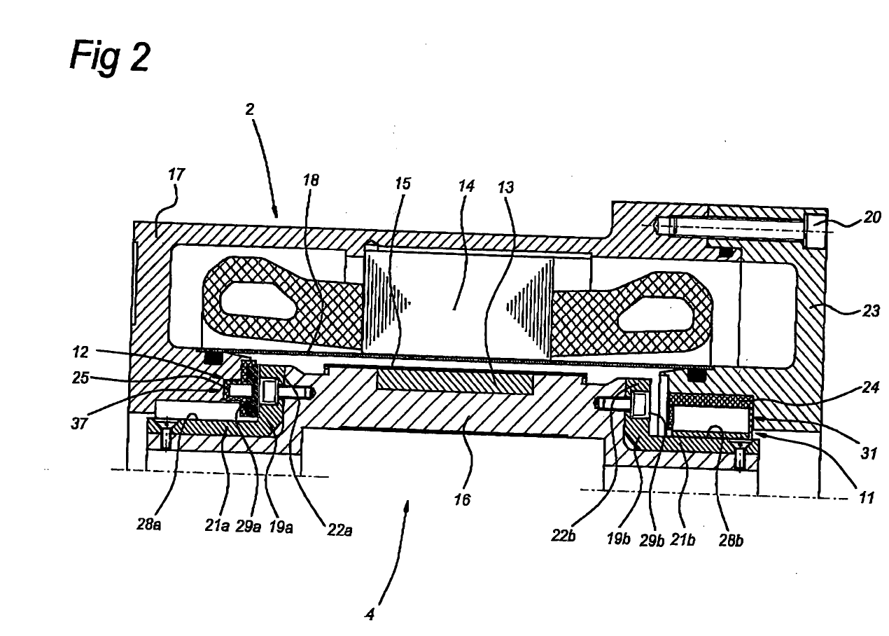

FIG. 2 is a partial sectional view of the propulsion propeller, the bearings being visible;

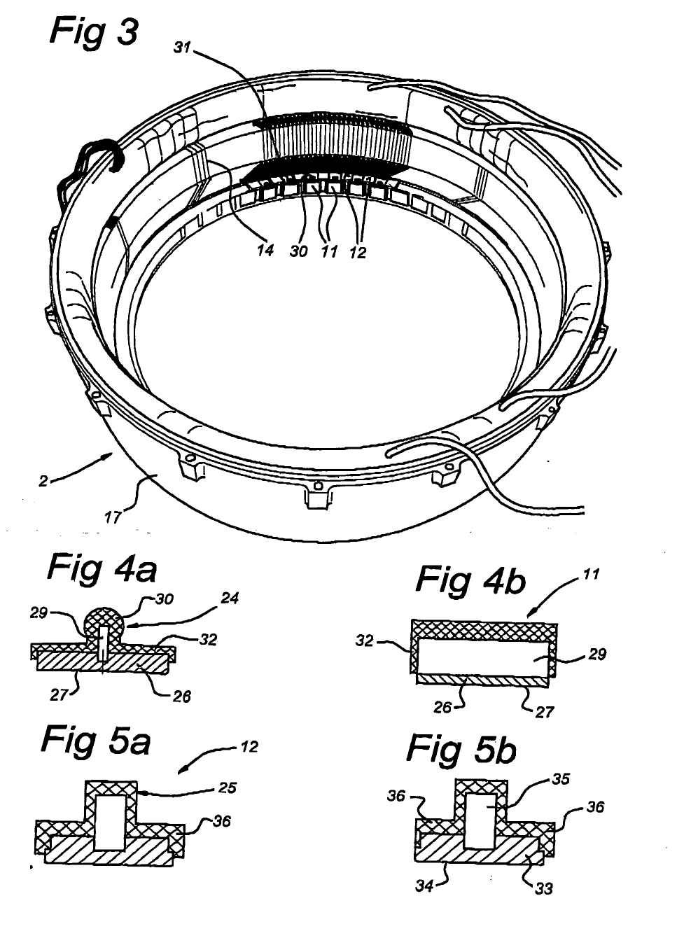

FIG. 3 is a perspective view of the stator, the configuration of the bearing pads being clearly visible;

FIGS. 4a and 4b are sectional views of a bearing pad of the radial bearing; and

FIGS. 5a and 5b are sectional views of a bearing pad of the axial bearing.

FIGS. 1 and 1b show a propulsion propeller 1 according to the invention. The propeller 1 comprises a stator 2 having a circular opening 3. In the opening is mounted a rotor 4 comprising an annular rotor body 16 and propeller blades 5 projecting inward from said annular body. Preferably, the propeller blades 5 are detachably connected to the rotor body 16, so they may be exchanged relatively easily. The annular body is provided with permanent magnets 13 which are configured along the circumference and cooperate with stator windings 14 configured around the opening of the stator 2 for driving the rotor 4.

FIG. 2 is a cross section of the rotor 4 and the stator 2, the bearings being clearly visible. The annular set of stator windings 14 are attached in the stator housing 17. On the side of the stator windings 14 that faces the rotor 4, the stator bout 17 is closed by means of an annular wall 18 consisting of a material which does not have an adverse effect on the magnetic field such as, for example, a composite material. The stator housing 17 is also closed by a removable annular lid 23 which is fastened to the stator housing 17 by bolts 20. Before the stator housing 17 is closed by the lid 23, it may be filled with a curable material, such as epoxy resin, which is then cured. This provides very reliable protection from environmental influences for the stator windings 14. The free-flowing epoxy resin poured into the stator housing may advantageously be cured by activating the stator windings with an electric current. The development of heat in the stator windings then causes the resin to cure. At the circumference, the rotor 4 is provided with permanent magnets 13 which oppose the stator windings 14 and are hermetically sealed from the environment.

The bearings comprise bearing pads 11 for radially mounting the rotor 4 and bearing blocks 12 for axially mounting the rotor 4. The bearing surface 28a, 28b, 29a, 29b of the rotor opposes the bearing pads. This bearing surface is located on annular bearing parts 19a, 19b fixed to opposing sides of the rotor.

These big parts 19a, 19b have an annular portion 21a, 21b with a bearing surface 28a, 28b facing the bearing pads 11 for radially mounting the rotor. The bearing parts 19a, 19b also have a flange 22a, 22b extending from the annular portion 21a, 21b and having a bearing surface 29a, 29b facing the bearing pads 12 for axially mounting the rotor. The space between the bearing pads 11, 12 and the bearing surface of the rotor is openly connected to the environment, allowing water to infiltrate said space and lubricate the bearing.

The bearing parts 19a and 19b may be constructed from a plurality of segments (not visible in the Figures), for example four segments extending over an arc of a circle of 45°. Producing the bearing part in segments makes them simpler to produce and to handle; this is particularly important in the case of relatively large propeller diameters, for example greater than 450 mm.

The cross section shown in FIG. 2 shows on one side of the stator 2, the left-hand side as shown in the drawing, merely the axial bearing pads 12, whereas on the other side of the stator 2, the right-hand side as shown in the drawing, only the radial bearing pads 11 may be seen. However, both types of bearing pads are located on both sides of the stator, as may be seen in FIG. 3.

FIG. 3 shows the configuration of the radial and axial bearing pads 11, 12 on one side of the stator 2. The bearing pads are tiltably fastened, along the circumference, to the stator 2. The side of the bearing pads 11, 12 that is remote from the bearing surface is accordingly provided with respective projections 24, 25. These projections 24, 25 may be seen in FIGS. 4a, 4b and FIGS. 5a, 5b respectively.

FIG. 4a is a cross section of a tiltable pad 11 for the radial bearing, seen in a direction parallel to the centre line of the rotor 4. FIG. 4b shows this tiltable pad 11 in cross section along the line A-A. The tiltable pad consists of a steel bearing pad 26 having a hardened bearing surface 27 having a radius of curvature which corresponds substantially to the radius of curvature of the bearing surface 28a, 28b, cooperating with said first bearing surface 27, of the rotor. A strip 29 extends substantially perpendicularly from the side of the bearing pad 26 that opposes the bearing surface 27. The strip is fixed to the bearing pad 26 by being fastened, for example, in a groove in the bearing pad using an adhesive. The strip 29 also extends substantially parallel to the tilting axis of the tiltable pad—in FIG. 4a, perpendicularly to the plane of the drawing—over substantially the entire length of the bearing pad. On the side opposing the bearing surface 27, the tiltable pad is provided with a lining 32 consisting of rubber having a hardness of approximately 45° Shore. The lining 32 also surrounds strip 29. The projection 24 thus formed has, at its end remote from the bearing pad 26, a substantially cylindrical thickening 30 with a centre line which is substantially parallel to the tilting axis of the tiltable pad. During fastening of the tiltable pad 11 to the rotor 4, this cylindrical thickening 30 is inserted into an associated bore 31 in the rotor 4. This bore 31 has a centre line extending substantially parallel to the centre line of the rotor 4 and is open along a portion, located in proximity to the stator opening 3, of the region for receiving the projection 24.

FIG. 5a is a cross section of a tiltable pad 12 for the axial bearing. FIG. 5b shows this tiltable pad 12 in cross section along the line A-A. The tiltable pad consists of a steel bearing pad 33 having a hardened flat bearing surface 34. A pin 35 extends substantially perpendicularly from the side of the bearing pad 33 that opposes the bearing surface 34. This pin is fixed to the bearing pad 33 by being fastened, for example, in a recess in the bearing pad using an adhesive. On the side opposing the bearing surface 34, the tiltable pad is provided with a lining 36 consisting of rubber having a hardness of approximately 45° Shore. The lining also surrounds pin 35. During fastening of the tiltable pad 12, the projection 25 thus formed is inserted into a bore 37 in the rotor 4. This bore has a centre line extending substantially parallel to the centre line of the rotor 4.

What is claimed is:

1. Shiftless propeller (1), which propeller may be made to cooperate with a liquid, comprising a stator (2) having a circular opening (3) and a rotor (4) mounted in said opening and comprising an annular rotor body (16) with a multiplicity of inwardly projecting propeller blades (5), characterized in that the bearings between the rotor and stator comprise a tiltable padded bearing (6).

2. Propeller according to claim 1, wherein the tiltable padded bearing (6) comprises a multiplicity of bearing pads (11, 12) which are tiltably connected to the stator and also a bearing surface (28a, 28b, 29a, 29b), cooperating with said bearing pads, of the rotor.

3. Propeller according to claim 1, wherein the tiltable padded bearing is lubricated with surrounding water.

4. Propeller according to claim 1, wherein the bearing surface (27, 34) of the bearing pads (11, 12) is relatively hard and wherein the bearing surface (28a, 28b, 29a, 29b) of the rotor is relatively soft.

5. Propeller according to claim 1, wherein the coefficient of friction between the bearing surface (27, 34) of the bearing pads (11, 12) and the bearing surface (28a, 28b, 29a, 29b) of the rotor is relatively low.

6. Propeller according to claim 1, wherein the bearing pads (11, 12) consist of a metal or metal alloy, such as hard stainless steel or titanium, and wherein the bearing surface (27, 34) of said bearing pads is hardened by means of a covering layer consisting of titanium nitride or diamond-like carbon.

7. Propeller according to claim 1, wherein the bearing surface (28a, 28b, 29a, 29b) of the rotor consists of a plastics material such as, for example, high-density polyethylene.

8. Propeller according to claim 1, wherein the bearing pads (11, 12) are carried by a carrier element (32, 36) consisting of a resilient material such as rubber.

9. Propeller according to claim 1, wherein the bearings comprise a radial bearing (11).

10. Propeller according to claim 1, wherein the bearings comprise an axial bearing (12).

11. Propeller/motor unit comprising a propeller according to claim 1, permanent magnets (13) provided at the circumference of the rotor, and also stator windings (14), provided around the opening of the stator, for driving the rotor in cooperation with the magnets.

12. Propeller/motor unit according to claim 11, wherein the gap (15) between the magnets and the stator windings is greater than about 3 mm.

13. Propeller/motor unit according to claim 11, configured as a propulsion propeller for propelling a vessel.

14. Propeller/motor unit according to claim 11, configured as a pump for pumping a liquid.

15. Propeller/generator unit comprising a propeller according to claim 1, wherein the rotor (4) is driven by a flow of liquid through the rotor, stator windings (14) provided around the opening of the stator, and permanent magnets (13) provided at the circumference of the rotor, for generating an electric current when the rotor is driven.

16. Pump comprising a pump housing with a pump chamber and also a supply means and a discharge means which are connected to the pump chamber, characterized in that a propeller/motor unit according to claim 14 is located in the pump chamber.

17. Generator provided with a generator housing and also a supply means and a discharge means which are connected to the generator housing, characterized in that a propeller/motor unit according to claim 15 is located in the generator housing.
